(19) United States
(12) Patent Application Publication
(10) Pub. No.: US 2013/0253965 A1
(43) Pub. Date: Sep. 26, 2013

(54) TIME DEPENDENT TRANSACTION QUEUE

(71) Applicant: Roshin Joseph, Sunnyvale, CA (US)

(72) Inventor: Roshin Joseph, Sunnyvale, CA (US)

(21) Appl. No.: 13/829,110

(22) Filed: Mar. 14, 2013

Related U.S. Application Data
(60) Provisional application No. 61/613,819, filed on Mar. 21, 2012.

(51) Int. Cl. G06Q 20/40

(52) U.S. Cl. CPC G06Q 20/4016
USPC 705/5; 705/7.26

(57) ABSTRACT

Embodiments of the invention provide systems and methods for analyzing transaction data for a plurality of transactions to determine an order of priority for reviewing the transactions. A merchant processor server computer receives transaction data related to a plurality of transactions and determines which transactions are fraudulent, which transactions are not fraudulent and which transactions are indeterminate. The merchant processor server computer analyzes the transaction data for indeterminate transactions to determine which transactions have higher priority based on priority rules and reorders the transactions for review based on the priority.

### CROSS-REFERENCES TO RELATED APPLICATIONS

This application is a non-provisional application of and claims the benefit of priority of U.S. Provisional Application No. 61/613,819 filed on Mar. 21, 2012, which is herein incorporated by reference in its entirety for all purposes.

### BACKGROUND

Embodiments of the invention are directed to systems and methods for efficient processing of financial transactions.

Electronic commerce (e-commerce) transactions are conducted over electronic systems, such as, the internet or other computer networks. Such transactions may involve the purchase of goods or services. Transactions related to e-commerce are mostly card-not-present (CNP) transactions and therefore are more prone to fraud. In some cases, when a transaction is reviewed, it is not clearly fraud and it is not clearly authentic. In such cases, the transaction may pass to a human reviewer to make a decision as to whether or not the transaction should be approved or not approved.

In a conventional transaction review queue for the human reviewer, the transactions are reviewed in a first-in/first-out manner. This may not be desirable in some cases. For example, if a transaction relates to the purchase of an airline ticket for a flight that leaves in 6 hours and is flagged for review, the transaction review by the reviewer may not be timely if there are too many transactions and/or there are in insufficient number of reviewers that are available. In this case, it is possible that the transaction could be automatically declined, thus resulting in the loss of a potential sale. Additionally, the conventional system is inefficient as it does not make the best use of the reviewers time.

Embodiments of the invention address this and other problems, individually and collectively.

### BRIEF SUMMARY

Embodiments of the invention provide systems and methods for analyzing transaction data for a plurality of transactions to determine an order of priority for reviewing the transactions. A merchant processor server computer receives transaction data related to a plurality of transactions from webservers associated with different merchants. The merchant processor server computer may determine which transactions are fraudulent, which transactions are not fraudulent and which transactions are indeterminate. The transactions which are clearly fraudulent may be rejected. The transactions which are clearly not fraudulent may be accepted, and further processed. In some embodiments, the merchant processor server computer may generate and/or forward an authorization request message comprising the transaction amount to a payment processing network via an acquirer computer as part of a payment authorization process. The transactions which are indeterminate may be stored in a queue for review. The merchant processor server computer may then analyze transaction data for the indeterminate transactions to determine which transactions have higher priority based on predetermined priority rules. The transactions which have higher priority based on the transaction data may be reviewed before the other transactions in the queue.

One embodiment of the invention relates to a method receiving first transaction data for a first transaction, analyzing, by a server computer, the first transaction data to determine if the first transaction is fraudulent, not fraudulent or indeterminate, determining, by the server computer, that the first transaction is indeterminate, storing the first transaction data in a queue for review, after receiving the first transaction data, receiving second transaction data for a second transaction, analyzing, by the server computer, the second transaction data to determine if the second transaction is fraudulent, not fraudulent or indeterminate, determining, by the server computer, that the second transaction is indeterminate, storing the second transaction data in the queue for review, analyzing, by the server computer, the first transaction data and the second transaction data to determine which of the first and second transactions has higher priority, determining, by the server computer, that the second transaction has higher priority; and reordering the queue so that the second transaction is reviewed before the first transaction.

One embodiment of the invention relates to a server computer comprising a processor, a computer readable medium coupled to the processor, the computer readable medium comprising code, executable by the processor for implementing a method comprising receiving first transaction data for a first transaction, analyzing the first transaction data to determine if the first transaction is fraudulent, not fraudulent or indeterminate, determining that the first transaction is indeterminate, storing the first transaction data in a queue for review, after receiving the first transaction data, receiving second transaction data for a second transaction, analyzing the second transaction data to determine if the second transaction is fraudulent, not fraudulent or indeterminate, determining that the second transaction is indeterminate, storing the second transaction data in the queue for review, analyzing the first transaction data and the second transaction data to determine which of the first and second transactions has higher priority, determining that the second transaction has higher priority; and reordering the queue so that the second transaction is reviewed before the first transaction.

These and other embodiments of the invention are described in further detail below.

### BRIEF DESCRIPTION OF THE DRAWINGS

FIG. 1 illustrates an exemplary system 100 with at least some of the elements for implementing embodiments of the invention.

FIG. 2 illustrates at least some of the elements of a merchant processor server computer in accordance with embodiments of the invention.

FIGS. 3A and 3B illustrate exemplary flowcharts illustrating methods for reordering the transactions based on priority, according to embodiments of the invention.

FIG. 4A shows details for an exemplary transaction for purchase of a book.

FIG. 4B shows details of an exemplary transaction for purchase of jewelry at a promotional event.

FIGS. 5A and 5B show details of exemplary transactions for the purchase of airline tickets.

FIGS. 6A-6B illustrates examples of time dependent reordering of transactions using embodiments of the invention.

FIG. 7 shows an exemplary computer apparatus in accordance with some embodiments.

### DETAILED DESCRIPTION

Conventional fraud evaluation systems can perform a fraud evaluation on all the incoming transactions, where some transactions could be easily classified as non-fraudulent and some other transactions could be easily classified as fraudulent. However, some transactions may be indeterminate and may require further review before classifying them as fraudulent or non-fraudulent.

Indeterminate transactions may include some transactions that are more time sensitive than some other transactions; for example, a transaction involving purchase of an air ticket for the same day flight may be more time sensitive than a transaction involving purchase of a book. In most cases, the transactions are reviewed in the order they are received. Therefore, some transactions that may be time sensitive may not be reviewed in a timely manner, hence, resulting in delayed processing of such time sensitive transactions. In such cases, this may result in frustration for the consumers as well as inefficient use of resources for the merchants and financial institutions.

Embodiments of the invention solve this and other problems. Embodiments of the invention can reorder transactions that have been classified as indeterminate, so that transactions with a higher priority are reviewed by a human reviewer before transactions with a lower priority. The reordering can change the order of transaction review based on the conventional first-in/first-out process. The priority of transaction review may be based on a number of factors including the time difference between the initiation of the purchase transaction and the time when the service to be purchased is to take place or when the good to be purchased is delivered. Further prioritization rules may be based on other transaction details such as transaction amounts.

Prior to discussing embodiments of the invention, description of some terms may be helpful in understanding embodiments of the invention.

A “transaction” may include exchange of data and/or information between two entities. A transaction may involve a purchase of goods or services, such as, food, books, flowers, drugs, supplies, apparel, electronics, and tickets for airlines, events such as plays, sports, movies, etc. An e-commerce transaction may be a transaction conducted online using the internet or a computer network. The transaction may be conducted using a client device that may be suitable for communicating with a web server associated with a merchant. Some examples of client devices include mobile phones, PDAs, personal computers (PCs), tablets, notebooks, and the like. Some transactions may be more time sensitive than other transactions, i.e., some transactions need to be processed before other transactions.

“Transaction data” may refer to data relating to a transaction. For example, transaction data may include a transaction amount, the last four digits of an account number, a merchant name and location, a date and time of the transaction, a merchant category, etc. In some embodiments, transaction data may include data relating to the product or service. For example, for a transaction involving the purchase of an airline ticket, the transaction data may include the departure time of the flight, the departing airport, the flight number, the airline name, etc. In another example, for a transaction involving a purchase at or during a special event, such as, a valentine day sale, the transaction data may include the time period for the sale. In some embodiments, the transaction data may be used to determine which transactions should be processed before other transactions.

“Priority rules” may refer to rules that may be used to assign a priority to each transaction in a transaction queue. In one embodiment, priority rules may be different for each merchant. For example, priority rules may be different for an airline merchant than for an electronics merchant. In some embodiments, priority rules may be different for different product categories for the same merchant. For example, a retail merchant may sell drugs, books, office supplies, food, tickets for events, etc. There may be one set of priority rules for food, whereas, there may be other set of priority rules for airline tickets.

A “fraudulent transaction” may refer to a transaction that was conducted by an unauthorized entity. For example, a fraudulent transaction may be conducted using a payment account that does not belong to the buyer. In some embodiments, fraud analysis algorithms may evaluate transaction data to determine if a transaction is fraudulent or not based on certain fraud rules.

An “indeterminate transaction” may refer to a transaction that a computer apparatus has determined is not clearly fraudulent or not clearly authentic according to predetermined thresholds. For example, on a fraud scale of 1-100, where 100 is the highest fraud and 1 is the lowest fraud, a merchant may have defined rules in a fraud system whereby transactions that have a fraud score of 70-100 are automatically rejected as being potentially fraudulent. Transactions with a fraud score of 1-50 are clearly authentic in view of an exemplary merchant, and these transactions are automatically approved for further processing. Transactions with a score between 50-70 are indeterminate and may be passed on for further human review before they are authorized or denied.

A “review” of a transaction may include an analysis of transaction data. The review may be performed by a human being that is knowledgeable about the types of transactions being reviewed.

A “queue” may include a particular sequence of a particular item. Transactions in a particular queue may be stored in a memory.

“Reordering” may include changing the order of items in a queue. For example, transactions may be reordered in a queue so that a transaction at the bottom of the queue is moved to the top or middle of the queue, or vice-versa.

A “consumer” may be an entity, such as, an individual that may be able to conduct an online transaction using a client device, e.g., a mobile device or a personal computer. The client device may be configured to communicate with a web server associated with a merchant via the internet or any other communications network in order to initiate the transaction. The transaction may relate to a purchase of goods or services.

A “server computer” is typically a powerful computer or cluster of computers. For example, the server computer can be a large mainframe, a minicomputer cluster, or a group of servers functioning as a unit. In one example, the server computer may be a database server coupled to a Web server.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

Embodiments of the invention provide systems and methods for analyzing transaction data for a plurality of transactions to determine an order of priority for reviewing the transactions. A merchant processor server computer receives transaction data related to a plurality of transactions from webservers associated with different merchants. The merchant processor server computer may determine which transactions are fraudulent (e.g., according to predetermined standards or thresholds), which transactions are not fraudulent and which transactions are indeterminate. The transactions which are clearly fraudulent may be rejected. The transactions which are clearly not fraudulent may be approved or temporarily approved. If temporarily approved, the merchant processor server computer may generate and/or forward an authorization request messsage to a payment processing network via an acquirer computer as part of an authorization request message. The payment processing network may forward the authorization request to an issuer for final approval and authorization. The transactions which are indeterminate may be stored in a queue for review. The merchant processor server computer may then analyze transaction data for the indeterminate transactions to determine which transactions have higher priority. The transactions which have higher priority based on the transaction data may be reviewed before the other transactions in the queue. In some embodiments, the order of priority is determined based on priority rules specific to a merchant profile.

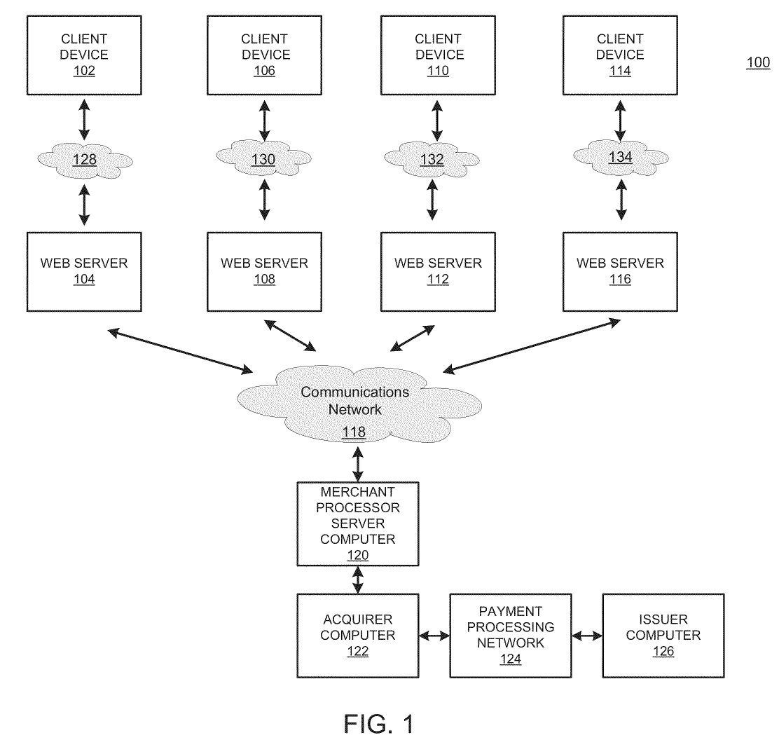

FIG. 1 illustrates an exemplary system 100 with at least some of the elements for implementing embodiments of the invention.

A plurality of transactions may be conducted at any given time between consumers and merchants for purchase of goods and services. FIG. 1 shows a number of client devices 102, 106, 110, 114, that may respectively communicate with a number of merchant web servers 104, 108, 112, 116. Communications between these respective entities may be performed via a number of communications networks 128, 130, 132, 134. The communications networks 128, 130, 132, 134 may be any electronic computer network, such as, the internet based on a standard TCP/IP protocol. In some embodiments, the client devices (e.g., mobile phones) 102, 106, 110, 114 may also be configured to communicate with one or more cellular networks. Although specific numbers of client devices, web servers, and communications networks are illustrated, embodiments of the invention are not limited thereto.

The client device 102, client device 106, client device 110 and client device 114 may be of the same type or different. For example the client device 102 may be a mobile phone, whereas, the client device 114 may be a personal computer. The web server 104, web server 108, web server 112 and the web server 116 may be associated with different merchants. For example, the web server 104 may be associated with an airline merchant, whereas, the web server 108 may be associated with a retailer of good. In some embodiments, the web servers may be configured to present to the consumers web pages associated with various merchants using Hypertext Transfer Protocol (HTTP).

A merchant processor server computer 120 may be configured to receive transaction data for each transaction via a communications network 118. The communications network 118 may comprise a plurality of networks for secure communication of data and information between different web servers and the merchant processor server computer 120. In some embodiments, the communications network 118 may follow a suitable communication protocol to generate one or more secure communication channels between the merchant processor server computer 120 and the web servers 104, 108, 112 and 116. Any suitable communications protocol may be used for generating a communications channel. A communication channel may in some instance comprise a “secure communication channel,” which may be established in any known manner, including the use of mutual authentication and a session key and establishment of an SSL session. However, any method of creating a secure channel may be used. By establishing a secure channel, sensitive information related to a payment device (such as account number, CVV values, expiration dates, etc.) may be securely transmitted between the web servers and the merchant processor server computer 120 to facilitate a transaction.

The merchant processor server computer 120 may receive the transaction data for each transaction from different web servers associated with different merchants The merchant processor server computer 120 may determine which transactions are fraudulent, which transactions are not fraudulent and which transactions are indeterminate. The transactions which are clearly fraudulent in the view of a particular merchant may be rejected. The transactions which are clearly not fraudulent may be approved or temporarily approved. If the transaction is temporarily approved, the merchant processor server computer 120 may generate and/or transmit an authorization request message to an issuer computer 126 via the payment processing network 124 and the acquirer computer 122. The transactions which are indeterminate may be stored in a queue in a memory in the merchant processor server computer 120 for review. The merchant processor server computer 120 may then analyze transaction data for the indeterminate transactions to determine which transactions have higher priority and accordingly reorder the queue so that the transactions with higher priority may be reviewed before the other transactions in the queue. In some embodiments, the order of priority is determined based on priority rules specific to a merchant profile.

The acquirer computer 122 is typically a system for an entity (e.g., a bank) that has a business relationship with a particular merchant or other entity. The acquirer computer 122 may route the authorization request for a transaction to an issuer computer 126 via the payment processing network 124.

The payment processing network 124 may include data processing subsystems, networks, and operations used to support and deliver authorization services, and clearing and settlement services. An example of payment processing network 124 includes VisaNet®, operated by Visa®. The payment processing network 124 may include wired or wireless network, including the internet.

The issuer computer 126 is typically a computer run by a business entity (e.g., a bank) that may have issued the payment (credit/debit) card, account numbers or payment tokens used for the transactions. Some systems can perform both issuer computer 126 and acquirer computer 122 functions. When a transaction involves a payment account associated with the issuer computer 126, the issuer computer 126 verifies the account and responds with an authorization response message to the acquirer computer 122 that may be forwarded to the corresponding web server associated with a merchant and the client device if applicable. If the authorization is approved, the transaction may be completed and the consumer associated with the transaction may be notified that the transaction was successfully completed.

At a later time (e.g., at the end of the day), a clearing and settlement process can occur between the acquirer computer 122, the payment processing network 124, and the issuer computer 126.

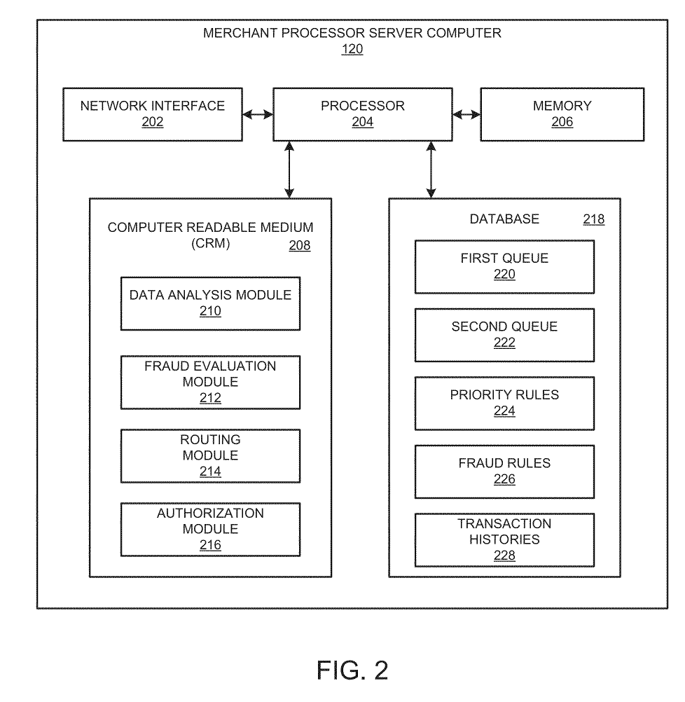

FIG. 2 illustrates at least some of the elements of a merchant processor server computer in accordance with embodiments of the invention.

The merchant processor server computer 120 may be configured to receive a plurality of transactions from a merchant and re-order the plurality of transactions based on priority rules specific to that merchant. The merchant processor server computer 120 may comprise a network interface 202, which may be configured to interface with other entities, such as, the acquirer computer 122, web servers, etc. for exchange of data and information (e.g., transaction and authorization related data) using various communications networks. It may also include a memory 206 may be coupled to a processor 204 internally or externally (e.g., cloud based data storage) and may comprise any combination of volatile and/or non-volatile memory such as, for example, buffer memory, RAM, DRAM, ROM, flash, or any other suitable memory device.

The processor 204 or processing elements may be configured to execute instructions or code in order to implement methods, processes or operations. The merchant processor computer 120 may also include a computer readable medium (CRM) 208, which may also be in the form of a memory, and may comprise code, executable by the processor 204 for implementing methods described herein. The CRM 204 may comprise a data analysis module 210, a fraud evaluation module 212, a routing module 214, and an authorization module 216.

The merchant processor server computer 120 may also comprise a database 218 coupled to the processor 204. The database 218 may be embodied by a memory as well and may comprise a first queue 220, a second queue 222, priority database 224, fraud rules 226 and transaction histories 228. The first queue 220 may be configured for storing all the indeterminate transactions and the second queue 222 may be configured for storing the reordered transactions that may have been reordered based on one or more rules stored in the priority rules database 224. In one embodiment, the first queue 220 and the second queue 222 can be implemented as one priority queue such that transactions in the queue are reordered based on a priority. For example, transactions with higher priority may be on top of the queue as compared to other low priority transactions.

The data analysis module 214 may be configured to receive and analyze transaction data for a transaction conducted by a consumer using a client device. For example, the transaction data may be associated with a transaction for an airline ticket conducted at the web server 104 using the client device 102. The transaction data may be received by the network interface 202 via the communications network 118. The transaction data may include one or more of a consumer identification information (i.e., name, shipping address, billing address, phone number, etc.), an account identifier, a transaction amount, a merchant identifier, a product description, a merchant category, a product category, quantity, a date and time of the transaction, a sale period, and any such information relevant to the transaction. The account identifier may be associated with a payment device (i.e., a payment card) or a payment account that may have been issued by the issuer computer 126. In one embodiment, the account identifier is a payment account number (PAN).

The merchant identifier may be an identifier associated with the merchant who may be the seller of the product. The merchant category may classify the merchant under certain category, for example, the merchant category may be electronics, food, books, travel, drugs, movies, sports events, etc. The product category may further classify the purchased product uncertain category, for example, children books, perishable items, airline tickets, hotels, etc. The transaction amount may indicate the amount of the transaction conducted by the consumer. The date and time indicate the date and time when the transaction was conducted. The sale period indicates the dates or the time duration during which the sale price may be valid. In some embodiment, the transaction data may also include the location where the transaction was conducted, for example, for an online transaction conducted using a mobile phone in a location different than the billing address of the consumer may have significance for fraud evaluation of the transaction. The location of the mobile device may be determined using a location based service associated with the mobile device, e.g., GPS.

The product description may include description of the product. In some embodiments, the product description may include timing of certain events associated with the transaction. For example, for a transaction involving purchase of an airline ticket or a ticket to a sports event, the product description may include flight information (i.e., departure time and the airport) or the timing of the sports event. In another example, a transaction involving a promotional sale or event may include a time duration for which the promotion or sale is valid.

The fraud rules 226 may include rules for fraud detection of incoming transactions. Fraud rules may be specific to each merchant, category of transaction, amount of transaction, location of transaction or any such criteria that may be used to differentiate between fraudulent and non-fraudulent transactions. In some embodiments, fraud rules may be updated based on the transaction histories 228 that contains historical transaction data. The transaction histories 228 may include transaction histories for a plurality of transactions that may be associated with the same payment account, same consumer or the same merchant. In some embodiments, fraud rules may be set up such that a transaction may be classified as clearly fraudulent, clearly non-fraudulent or indeterminate. For example, based on transaction history database 228, if a consumer has a history of purchasing office supplies from a certain online store for amounts less than $50, a similar transaction may be classified as clearly non-fraudulent. In another example, if a consumer has a history of making purchases for less than $100 at a certain online store then a transaction of over $500 at that store may require further review and may be classified as indeterminate. In one embodiment, if the transaction amount is over certain amount (e.g., $1000) and shipping address is based in a different country then that transaction may be classified as clearly fraudulent. For example, if a consumer has no history of purchasing sports merchandise then a transaction amount of over $1000 for golf merchandise shipped to a country different than the resident country of the consumer may indicate a clearly fraudulent transaction.

The priority rules 224 may include rules for prioritizing the transactions such that a transaction with a higher priority may be reviewed before the other low priority transactions. The priority rules 224 may include different rules for different merchants. For example, rules for an airline merchant may be different than a merchant of a retail store. In one embodiment, the rules for an airline merchant may be based on the departure time of the flight, e.g., a same day flight may have a higher priority than a next day or next month flight. In some embodiments, the rules may be based on the transaction amount. In some embodiments, for a retail merchant selling products in different categories (e.g., drugs, food, electronics, office supplies, toys, books, etc.), rules may be based on the category of the product. For example, food items may have higher priority than books or toys. In some embodiments, the rules may be further based on sub-categories of the products, e.g., perishable food items may have higher priority than non-perishable food items. In some embodiments, the rules may be based on the timing of a promotional sale or event (e.g., Valentine's Day sale, Mother's day or Father's day sale) since such sales or promotions may be valid only for a certain duration of time. In some embodiments, rules may be based on time of shipment. For example, a transaction with a shipment speed of two days may be given priority over a transaction with a standard shipping speed.

In one embodiment, priority rules may include rules for assigning priority to certain transactions that have been in a transaction queue for certain duration (e.g., one hour) and have not been reviewed yet. For example, a priority rule may imply that a transaction that has been in the transaction queue for more than one hour may be automatically approved or rejected.

The data analysis module 214 may be further configured to analyze the transaction data stored in the queue to assign a priority for each transaction. In some embodiments, the priority is assigned based on priority rules specific to a merchant. For example, a transaction for purchasing an airline ticket for a flight leaving the same day may be assigned higher priority than a transaction for a flight leaving next week. The priority rules to assign priority may be pre-determined by the merchant processor computer 120, payment processing network 124 or the issuer computer 126.

The routing module 218 may route the transaction to the appropriate recipient based on the outcome of the fraud evaluation of the transaction. If the transaction is determined to be clearly fraudulent, the routing module 218 may transmit a transaction declined message to the web server associated with the merchant and/or to the client device where the transaction was initiated. The transaction declined message may include part of the transaction data, a code that may indicate a reason for declining the transaction and any other relevant information. If the transaction is determined to be clearly non-fraudulent, an authorization request may be generated by the authorization module 220 for processing the transaction.

An authorization module 220 may be configured to generate and process authorization request and response messages. The authorization module 220 may also determine the appropriate destination for the authorization request and response messages. The authorization module 220 may be configured to generate an authorization request message for further processing of the clearly non-fraudulent transactions. The routing module 218 may further route the authorization request message to the payment processing network 124 via the acquirer computer 122 for processing the request. In some embodiments, the payment processing network 124 and the issuer computer 126 may perform additional fraud evaluation on the incoming transaction. The issuer computer 126 and the payment processing network 124 may transmit an authorization response message back indicating whether the transaction is approved or declined. For example, even if the transaction may be non-fraudulent, the payment account used for the transaction may not have enough funds for the current transaction resulting in a declined transaction.

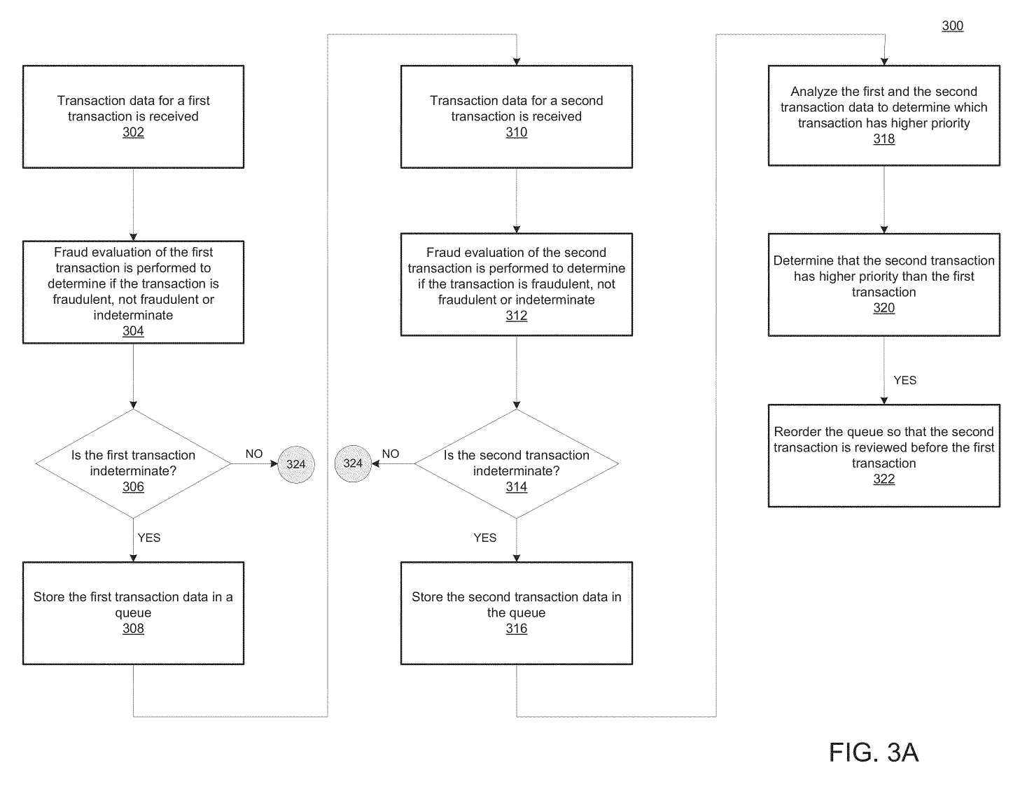

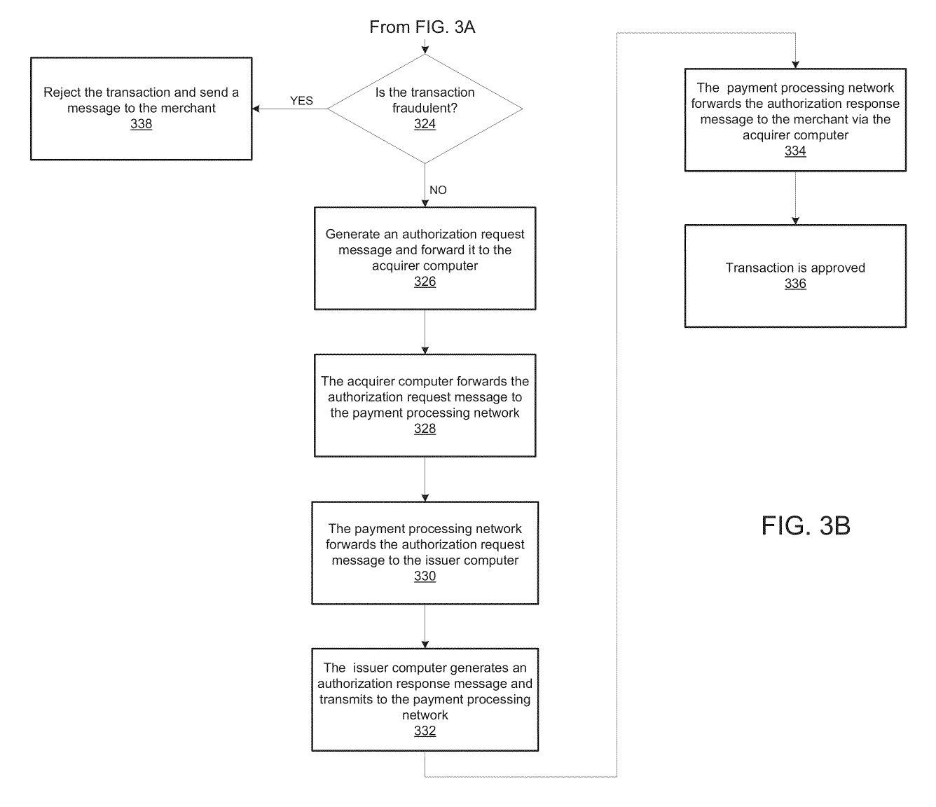

FIGS. 3A and 3B illustrate an exemplary flow chart 300 illustrating a method for reordering the transactions based on priority, in embodiments of the invention.

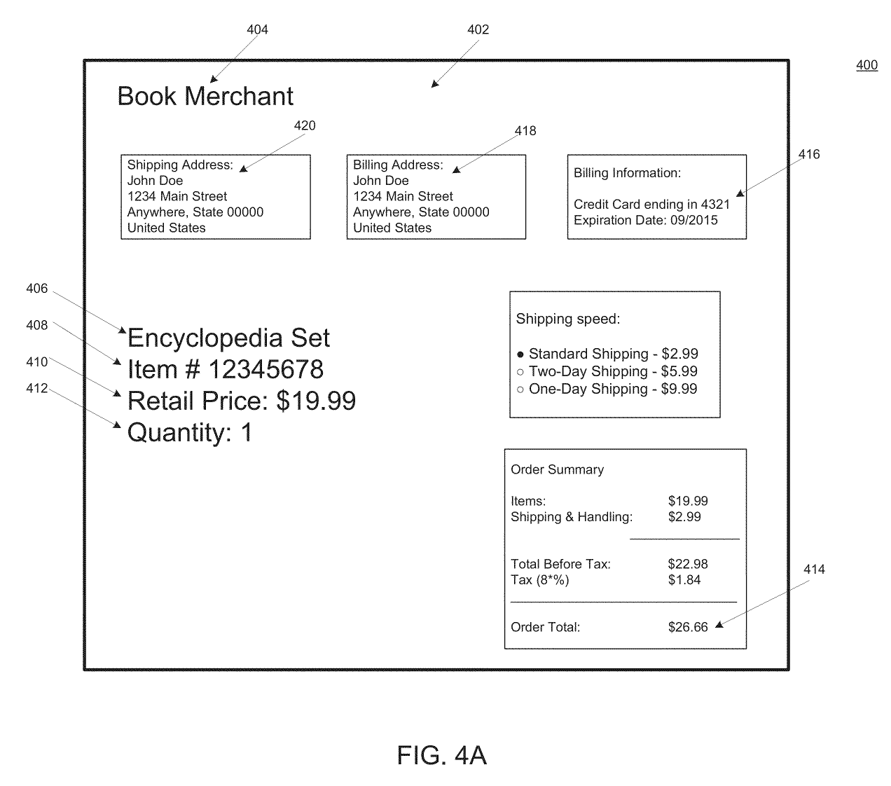

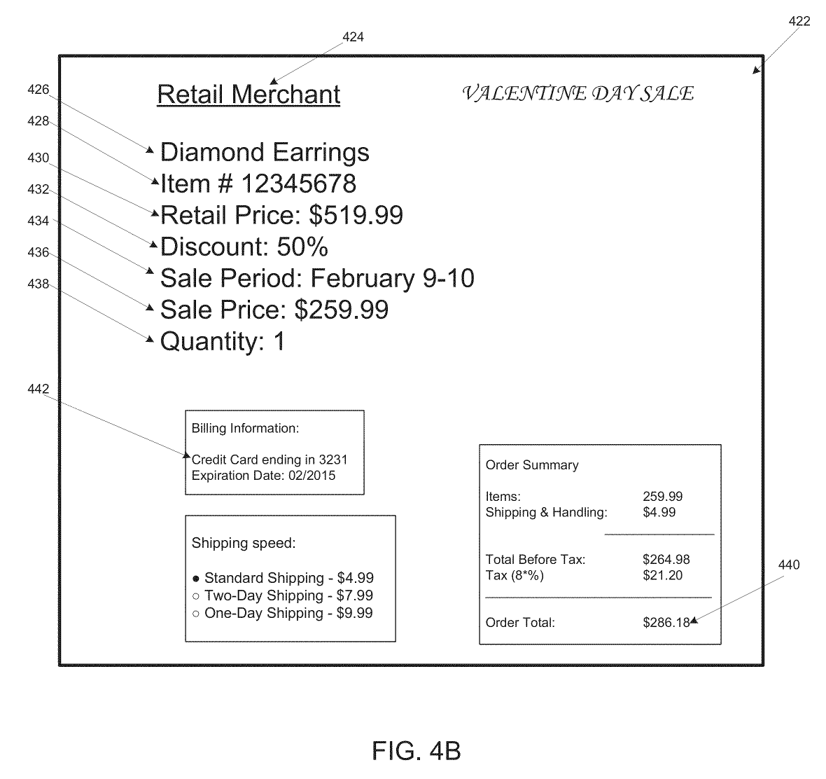

In step 302, transaction data for a first transaction is received by the merchant processor server computer 120. For example, a first consumer conducts a transaction to purchase a book at the web server 116 using the client device 114. Transaction data related to the transaction, such as, consumer identification information, an account identifier, a transaction amount, a merchant identifier, a product description, a product category, a quantity, a date and time, etc., may be transmitted to the merchant processor server computer 120 via the communications network 118. An exemplary transaction 402 for purchase of a book at a book merchant 404 is illustrated in a screen shot 400 in FIG. 4A. The transaction 402 includes a product description 406, a product identifier 408, a retail price 410, a quantity 412, a transaction amount 414, a last four digits of the credit card 416, a consumer's billing address 418, and a shipping address 420. Note that the last four digits of the credit card 416 may be part of the account identifier associated with the payment account used for the transaction 402.

In step 304, a fraud evaluation of the first transaction is performed to determine if the transaction is fraudulent, not fraudulent or indeterminate. In one embodiment, the fraud evaluation module 212 analyzes the transaction data for transaction 402 to determine if the transaction is clearly fraudulent or clearly not fraudulent based on the transaction history database 228.

In step 306, the data analysis module 210 may determine that the first transaction is indeterminate. For example, the consumer may not have a history of making purchases at the merchant associated with the web server 104 or the transaction may have been initiated at a client computer with an unfamiliar IP address. If the first transaction is indeterminate, the process flow moves to a step 308. If the first transaction is clearly fraudulent or not fraudulent, the process flow moves to a step 324, as discussed with reference to FIG. 3B.

In step 308, the transaction data for the first transaction is stored in a transaction queue. In one embodiment, the transaction data may be stored in the first queue 220.

In step 310, transaction data for a second transaction is received by the merchant processor server computer 120. For example, a second consumer conducts a transaction to purchase diamond earrings on a Valentine's Day sale at the web server 108 using the client device 106. Transaction data related to the transaction, such as, consumer identification information, an account identifier, a transaction amount, a merchant identifier, a product category, a product description, a sale period, a date and time, etc., may be transmitted to the merchant processor server computer 120 via the communications network 118. An exemplary transaction 422 for purchase of diamond earrings is illustrated in FIG. 4B. The transaction 422 includes a merchant identifier 424, a product description 426, a product identifier 428, a retail price 430, a discount 432, a sale period 434, a sale price 436, a quantity 438, a transaction amount 440, and an account identifier 442. Note that the sale period 434 indicates that the sale price 436 is valid only during that period (February 9-10).

In step 312, fraud evaluation of the second transaction is performed to determine if the second transaction is fraudulent, not fraudulent or indeterminate. In one embodiment, the fraud evaluation module 212 analyzes the transaction data for transaction 422 to determine if the transaction is clearly fraudulent or clearly not fraudulent based on the transaction history database 228.

In step 314, the data analysis module 210 may determine that the second transaction is indeterminate. For example, the consumer may not have made a purchase with the payment account used for the transaction in last 5 months. If the second transaction is indeterminate, the process flow moves to a step 316. If the second transaction is clearly fraudulent or not fraudulent, the process flow moves to the step 324, as discussed with reference to FIG. 3B.

In step 316, the transaction data for the second transaction is stored in the queue. Since the second transaction was conducted after the first transaction, the second transaction data may be stored in the first queue 220 after the first transaction data such that the second transaction may be reviewed after the first transaction.

In step 318, the first and the second transaction data is analyzed to determine which transaction has higher priority. In one embodiment, the data analysis module 212 may analyze transaction data associated with the transaction 402 and the transaction 422 to determine which transaction has higher priority.

In step 320, the data analysis module 212 may determine that the second transaction has higher priority than the first transaction. For example, the data analysis module 212 may determine from the sale period 434 included in the transaction data for the transaction 422 that the promotion expires by certain date, therefore the second transaction may be more time sensitive than the first transaction (purchase of a book) and needs to be reviewed first.

In step 322, the data analysis module 212 may reorder the queue so that the second transaction is reviewed before the first transaction. In one embodiment, the first queue 220 is reordered such that the transaction 424 will be on top of the queue. In another embodiment, the reordered transaction data is stored in the queue 222 such that the transactions are reviewed in the order stored in the queue 222.

In some embodiments, the transaction which is reviewed first may be processed before other transactions. For example, if the second transaction is reviewed first, it may be processed before the first transaction. In some embodiments, a second consumer who initiated the second transaction may receive goods and services before the first consumer who initiated the first transaction, e.g., the second consumer may receive the diamond earrings before the first consumer receives the book.

As illustrated in FIG. 3B, in step 324, the fraud evaluation module 214 may determine that the transaction is clearly fraudulent of not fraudulent, as determined by the particular merchant that is involved in the transaction. As noted above, each merchant may have different ways to score potential fraud and/or may have different thresholds for fraud determinations.

In step 338, if the transaction is determined to be clearly fraudulent then the transaction may be rejected. In one embodiment, a transaction rejection message may be transmitted to the web server associated with the merchant indicating that the transaction was rejected.

In step 326, an authorization request message is generated for non-fraudulent transactions. The authorization module 220 may generate an authorization request message including part of the transaction data and any other details for processing the authorization request message. The authorization request message may be transmitted to the acquirer computer 122.

In step 328, the acquirer computer 122 forwards the authorization request message to the payment processing network 124 for further processing of the transaction.

In step 330, the payment processing network 124 may forward the authorization request message to the issuer computer 126.

In step 332, the issuer computer 126 may further determine if the transaction may be approved or rejected based on the account information associated with the transaction. For example, the merchant processor computer 120 may determine a purchase transaction to be non-fraudulent, however, the issuer computer 126 may determine that the payment account used for the transaction has insufficient balance and may reject the transaction. The issuer computer 126 may generate an authorization response message and transmit to the payment processing network 124.

In step 334, the payment processing network 124 may forward the authorization response message to the web server associated with the merchant via the acquirer computer 122.

In step 336, the transaction may be approved and the consumer may be notified. For example, the consumer may get a receipt for the transaction on the mobile device or the client computer where the transaction was initiated.

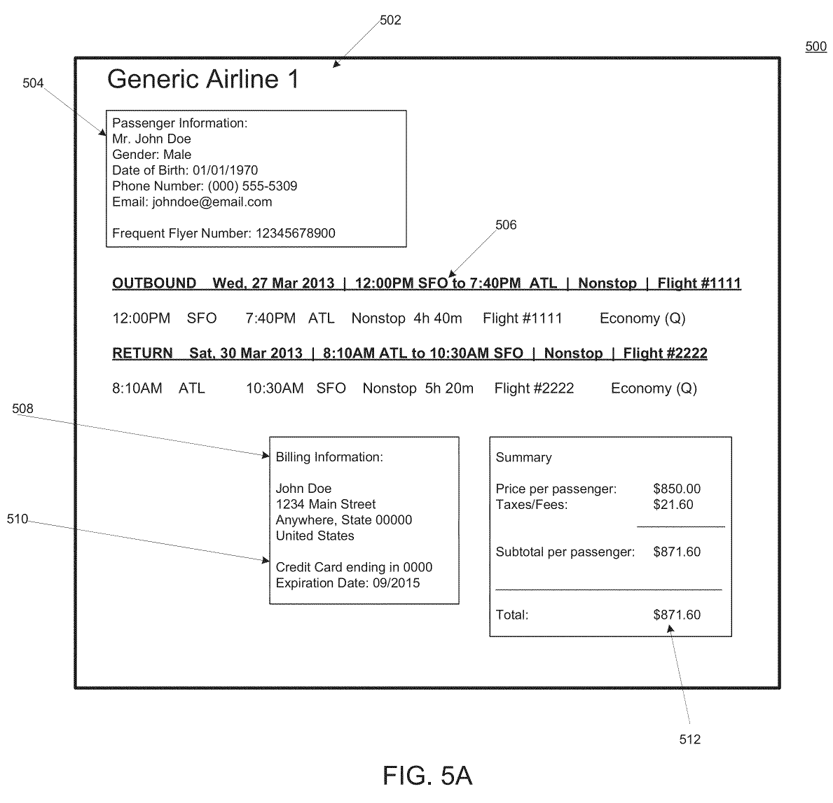

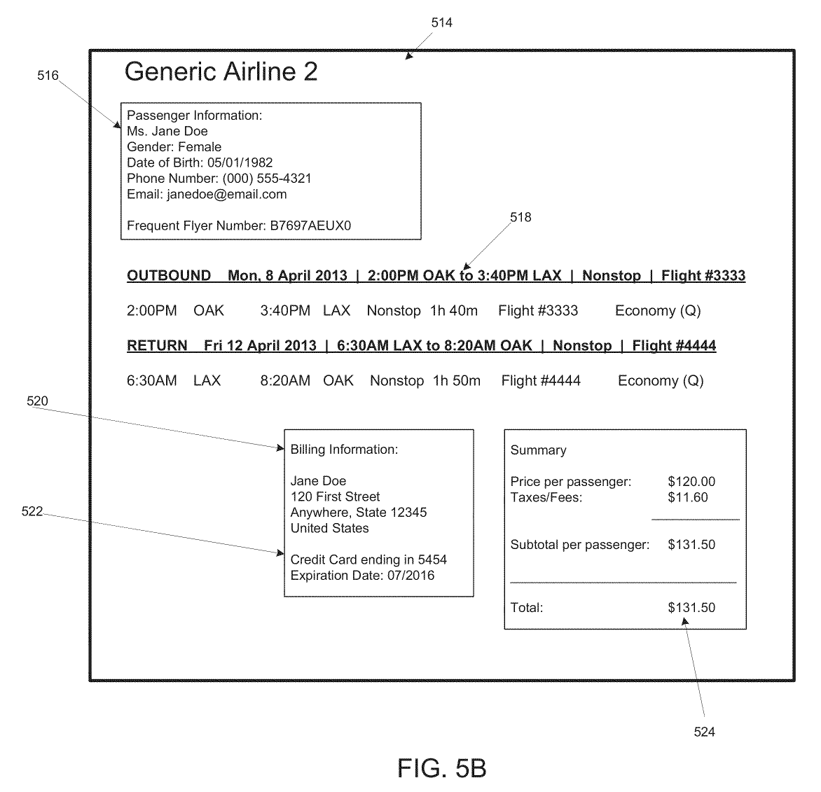

Embodiments of the invention are further discussed with reference to FIGS. 5A and 5B. FIGS. 5A and 5B illustrate exemplary transactions for airline tickets.

FIG. 5A illustrates exemplary transaction data 502 for the purchase of an airline ticket at a generic airline 1. The transaction 502 includes consumer identification information 504, a product description 506, a billing information 508, a last four digits of the credit card 510, and a transaction amount 512. Note that the last four digits of the credit card 510 may be part of the account identifier associated with the payment account used for the transaction 502. The product description 506 may include flight information, such as, flight departure and arrival times, flight numbers, date and time of the flight, and any such relevant information.

FIG. 5B illustrates exemplary transaction data 514 for purchase of an airline ticket at a generic airline 2 The transaction 514 includes consumer identification information 516, a product description 518, a billing information 520, a last four digits of the credit card 522, and a transaction amount 524. Note that the last four digits of the credit card 522 may be part of the account identifier associated with the payment account used for the transaction 514. The product description 518 may include flight information, such as, flight departure and arrival times, flight numbers, date and time of the flight, and any such relevant information.

In one embodiment of the invention, the data analysis module 210 receives transaction data for the transaction 502 and the transaction 514 from the web server 104 that may be associated with an airline merchant. Based on the flight information included in the transaction data, the data analysis module determines which transaction has higher priority based on a priority rule in the priority rules database 224 specific to airline merchants. For example, based on the flight information 506 for the transaction 502 and the flight information 518 for the transaction 514, the data analysis module 210 may determine that the flight associated with the transaction 514 departs before the flight associated with the transaction 502, and assigns higher priority to the transaction 518 such that the transaction 518 is reviewed before the transaction 502.

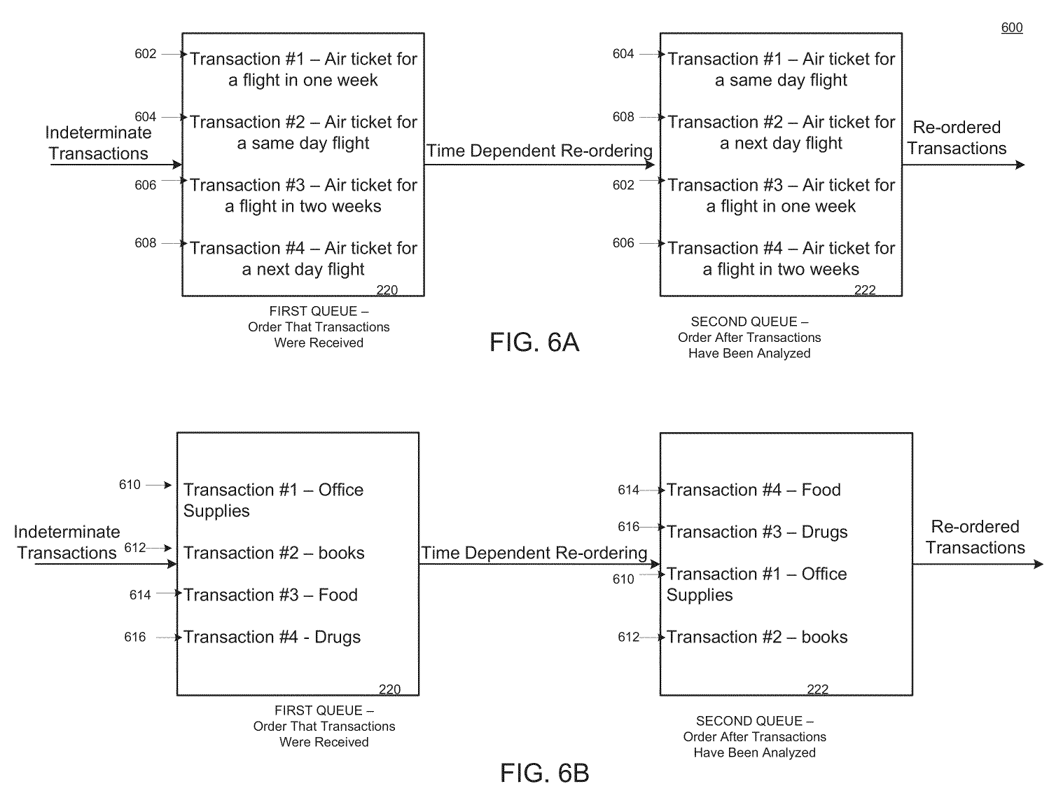

FIGS. 6A-6B illustrates examples of time dependent reordering of transactions using embodiments of the invention.

As illustrated in FIG. 6A, indeterminate transactions that need to be reviewed may include a transaction 602 for purchase of an air ticket for a flight in one week, a transaction 604 for purchase of an airline ticket for a same day flight, a transaction 606 for purchase of an air ticket for a flight in two weeks and a transaction 608 for purchase of an air ticket for a next day flight. The transactions may be stored in the first queue 220 in the order received.

In one embodiment of the invention, the data analysis module 210 may analyze the transaction data for each transaction (i.e., transaction 602, transaction 604, transaction 606 and transaction 608) stored in the first queue 220 and assign a priority to each transaction based on the priority rules stored in the priority conditions database 224. For example, the data analysis module 210 may determine that the transaction 604 relates to the purchase of an airline ticket for the same day flight as the purchase date and may be more time sensitive than other transactions. The data analysis module 210 may reorder the transactions based on the priority and store the reordered transactions in the second queue 222. For example, based on the transaction data for each transaction, the data analysis module 210 may reorder the transactions in the order of priority as transactions 604, 608, 602 and 606.

FIG. 6B, illustrates another exemplary queue with indeterminate transactions that need to be reviewed including a transaction 610 for purchase of office supplies, a transaction 612 for a purchase of a book, a transaction 614 for purchase of a food item and a transaction 616 for purchase of drugs. The transactions may be stored in the first queue 220 in the order received. In one embodiment, the transaction 602 may be conducted using the client device 102, the transaction 604 may be conducted using the client device 106, the transaction 606 may be conducted using the client device 110, and the transaction 608 may be conducted using the client device 114.

In one embodiment of the invention, the data analysis module 210 may analyze the transaction data for each transaction (i.e., transaction 610, transaction 612, transaction 614 and transaction 616) stored in the first queue 220 and assign a priority to each transaction based on the priority rules stored in the priority conditions database 224 for the merchant associated with the transactions. For example, the data analysis module 210 may determine that the transaction 614 relates to the purchase of a perishable food item and may be more time sensitive than other transactions. The data analysis module 210 may reorder the transactions based on the priority and store the reordered transactions in the second queue 222. For example, based on the transaction data for each transaction, the data analysis module 210 may reorder the transactions in the order of priority as transactions 614, 616, 610 and 612. In some embodiments, the data analysis module 210 may determine that the transaction 616 relates to the purchase of a prescription drug that may be more time sensitive than other transactions and reorder the transactions accordingly. In some embodiments, the first queue 220 and the second queue 222 are implemented as a single queue such that the reordered transactions are stored in the single queue.

Embodiments of the invention provide efficient processing of transactions by reordering the transactions such that the transactions with higher priority are reviewed before the other transactions. The priority may be assigned based on priority rules that may be specific to a merchant profile. The transactions with higher priority may be processed before the other transactions.

It is noted that other embodiments of the invention are also possible. In some embodiments, the above-described methods and systems may be combined with a second level review process, which is described in U.S. Patent Application No. 61/673,182, filed on Jul. 18, 2012, which is herein incorporated by reference in its entirety for all purposes. As described in the application, if a fraud score is non-determinative for a transaction, the transaction might proceed to a second computer for a second level review. When the first fraud score proceeds to a second computer, the second computer may receive the transaction file, billing information, first fraud score, and any other relevant information from the first computer in order to determine a second fraud score.

The second computer might conduct a different analysis from the first computer by querying different data sources to generate a second fraud score. Similar to the fraud threshold range for the first fraud score, the second fraud score can also provide an acceptable, unacceptable, and non-determinative fraud range based on a second fraud threshold range. If the transaction is determined to be indeterminate by the second computer, then the transaction may remain in the queues that are described above, and the prioritization methods can be applied to processing that occurs by the first computer and the second computer.

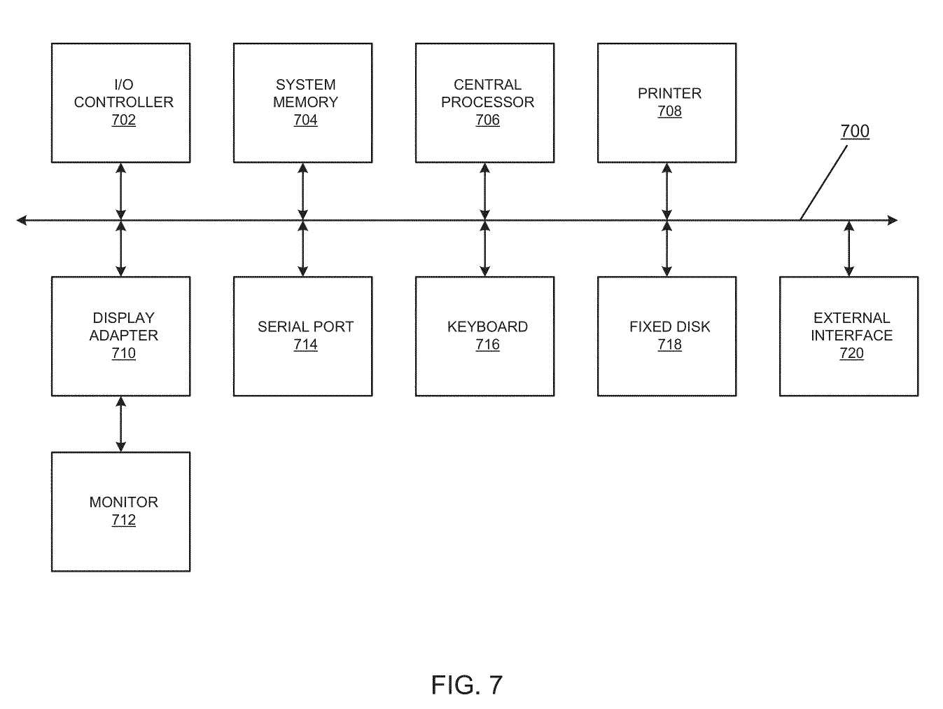

FIG. 7 is a high level block diagram of a computer system that may be used to implement any of the entities or components described above. The subsystems shown in FIG. 7 are interconnected via a system bus 700. Additional subsystems include a printer 708, keyboard 716, fixed disk 718, and monitor 712, which is coupled to display adapter 710. Peripherals and input/output (I/O) devices, which couple to I/O controller 702, can be connected to the computer system by any number of means known in the art, such as a serial port. For example, serial port 714 or external interface 720 can be used to connect the computer apparatus to a wide area network such as the Internet, a mouse input device, or a scanner. The interconnection via system bus 700 allows the central processor 706 to communicate with each subsystem and to control the execution of instructions from system memory 704 or the fixed disk 718, as well as the exchange of information between subsystems. The system memory 704 and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

As noted previously, all measurements, dimensions, and materials provided herein within the specification or within the figures are by way of example only.

A recitation of “a,” “an,” or “the” is intended to mean “one or more” unless specifically indicated to the contrary. Reference to a “first” component does not necessarily require that a second component be provided. Moreover reference to a “first” or a “second” component does not limit the referenced component to a particular location unless expressly stated.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

What is claimed is:

1. A method comprising:
receiving first transaction data for a first transaction;
analyzing, by a server computer, the first transaction data to determine if the first transaction is fraudulent, not fraudulent or indeterminate;
determining, by the server computer, that the first transaction is indeterminate;
storing the first transaction data in a queue for review;
after receiving the first transaction data, receiving second transaction data for a second transaction;
analyzing, by the server computer, the second transaction data to determine if the second transaction is fraudulent, not fraudulent or indeterminate;
determining, by the server computer, that the second transaction is indeterminate;
storing the second transaction data in the queue for review;
analyzing, by the server computer, the first transaction data and the second transaction data to determine which of the first and second transactions has higher priority;
determining, by the server computer, that the second transaction has higher priority; and
reordering the queue so that the second transaction is reviewed before the first transaction.

2. The method of claim 1, wherein a second consumer conducting the second transaction will receive goods or services before a first consumer conducting the first transaction will receive goods or services.

3. The method of claim 1, wherein the second transaction is for the purchase of goods that are perishable and the first transaction is for goods that are not perishable.

4. The method of claim 1, wherein the first and second transactions are electronic commerce transactions.

5. The method of claim 1, wherein the first transaction is for purchasing merchandise and the second transaction is for purchasing a ticket for a same day event.

6. The method of claim 1, wherein the first transaction is for purchasing an airline ticket for a next day flight and the second transaction is for purchasing an airline ticket for a same day flight.

7. The method of claim 1, wherein the determining, by the server computer, that the second transaction has higher priority is based on priority rules specific to a merchant associated with the first and the second transactions.

8. The method of claim 1, further comprising:
processing second transaction before the first transaction.

9. The method of claim 1, wherein the first transaction data and the second transaction data include one or more of a consumer identification information, an account identifier, a transaction amount, a merchant identifier, a product description, a merchant category, a date and time.

10. The method of claim 1, wherein the server computer is operatively coupled to a payment processing network that is located between a plurality of issuers and acquirers.

11. A server computer comprising:
a processor;
a computer readable medium coupled to the processor, the computer readable medium comprising code, executable by the processor for implementing a method comprising:
receiving first transaction data for a first transaction;
analyzing the first transaction data to determine if the first transaction is fraudulent, not fraudulent or indeterminate;
determining that the first transaction is indeterminate;
storing the first transaction data in a queue for review;
after receiving the first transaction data, receiving second transaction data for a second transaction;
analyzing the second transaction data to determine if the second transaction is fraudulent, not fraudulent or indeterminate;
determining that the second transaction is indeterminate;
storing the second transaction data in the queue for review;
analyzing the first transaction data and the second transaction data to determine which of the first and second transactions has higher priority;
determining that the second transaction has higher priority; and
reordering the queue so that the second transaction is reviewed before the first transaction.

12. The server computer of claim 11, wherein a second consumer conducting the second transaction will receive goods or services before a first consumer conducting the first transaction will receive goods or services.

13. The server computer of claim 11, wherein the second transaction is for the purchase of goods that are perishable and the first transaction is for goods that are not perishable.

14. The server computer of claim 11, wherein the first and second transactions are electronic commerce transactions.

15. The server computer of claim 11, wherein the first transaction is for purchasing merchandise and the second transaction is for purchasing a ticket for a same day event.

16. The server computer of claim 11, wherein the first transaction is for purchasing an airline ticket for a next day flight and the second transaction is for purchasing an airline ticket for a same day flight.

17. The server computer of claim 11, wherein the determining that the second transaction has higher priority is based on priority rules specific to a merchant associated with the first and the second transactions.

18. The server computer of claim 11, further comprising:
processing second transaction before the first transaction.

19. The server computer of claim 11, wherein the first transaction data and the second transaction data include one or more of a consumer identification information, an account identifier, a transaction amount, a merchant identifier, a product description, a merchant category, a date and time.

20. The server computer of claim 11, wherein the server computer is operatively coupled to a payment processing network that is located between a plurality of issuers and acquirers.
